(19) United States
(12) Patent Application Publication
(10) Pub. No.: US 2012/0075596 A1
(43) Pub. Date: Mar. 29, 2012

(54) HIGH EFFICIENCY ILLUMINATION

(76) Inventors: Eric C. Hannah, Pebble Beach, CA (US); John L. Gustafson, Santa Clara, CA (US)

(21) Appl. No.: 12/890,180

(22) Filed: Sep. 24, 2010

(51) Int. Cl. G03B 21/14; H05B 41/24

(52) U.S. Cl. 353/85; 315/287; 315/250; 353/121

(57) ABSTRACT

An electronic device comprises a processor, a light source, and a controller coupled to the light source. The controller comprises logic to cycle the light source between an active state and an inactivate state at with a pulse duration that measures between 30 milliseconds and 100 milliseconds and jitter a time onset of the active state by a quasi-random time that measures between 0 and 30 milliseconds for one or more cycles. Other embodiments may be described.

### RELATED APPLICATIONS

None.

### BACKGROUND

The subject matter described herein relates generally to the field of illumination and more particularly to high efficiency light sources and methods of generating highly efficient illumination.

The Broca-Sulzer effect is an optical and physiological effect in which the perceived luminance of an object increases when the illumination source is pulsed between full intensity and darkness. The Broca-Sulzer appears to have its maximum effect at pulse durations of approximately 50 milliseconds. Practical applications of the Broca-Sulzer effect have been limited by human physiology and by illumination technology. For reasons that are not perfectly understood, the Broca-Sulzer effect causes physical pain and even disorientation and seizures in observers. Aside from the physiological limitations, neither conventional incandescent nor fluorescent light sources can easily switch between states at the frequency required to achieve the Broca-Sulzer effect. Specialized illumination assemblies adapted to achieve the Broca-Sulzer effect have been prohibitively expensive for commercial applications. Accordingly, systems and methods to implement the Broca-Sulzer effect may find utility.

### BRIEF DESCRIPTION OF THE DRAWINGS

The detailed description is described with reference to the accompanying figures.

FIG. 1 is a schematic illustration of an exemplary illumination system which may be adapted to implement high efficiency illumination in accordance with some embodiments.

FIG. 2 is a flow diagram illustrating operations in a method to implement high efficiency illumination in accordance with some embodiments.

FIG. 3A is a graphic which illustrates the non-linearity of the Broca-Sulzer effect in accordance with some embodiments.

FIG. 3B is a graphic which illustrates a correction factor applied to a Broca-Sulzer effect in accordance with some embodiments.

FIGS. 4 and 5 are schematic illustrations of an electronic device which may be adapted to implement high efficiency illumination in accordance with some embodiments.

### DETAILED DESCRIPTION

Described herein are exemplary systems and methods for high efficiency illumination. More particularly, described herein are systems and methods when enable illumination systems to harness the Broca-Sulzer effect to produce highly efficient illumination. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

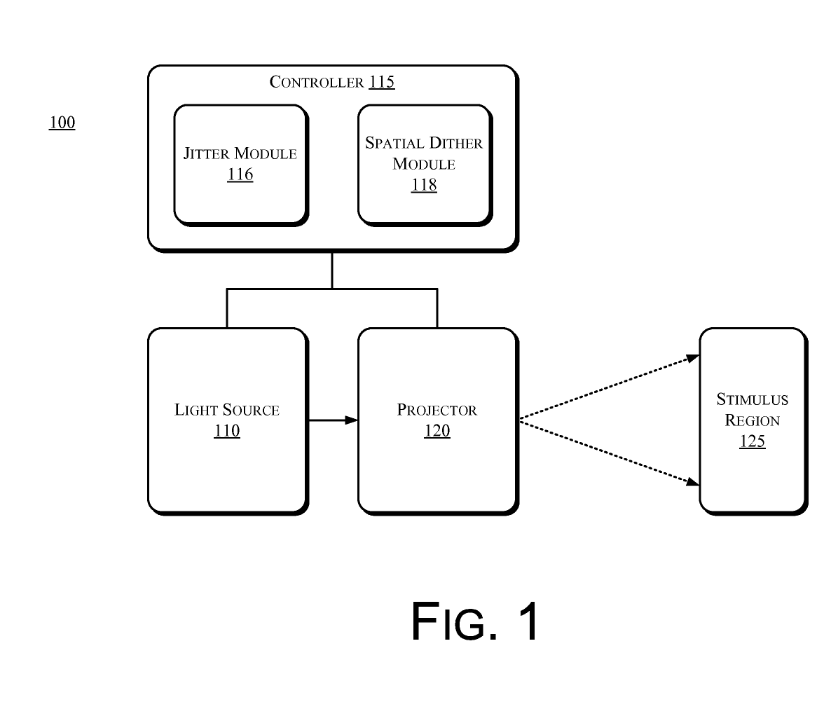

FIG. 1 is a schematic illustration of an exemplary illumination system which may be adapted to implement high efficiency illumination in accordance with some embodiments. Referring to FIG. 1, in some embodiments, system 100 comprises a controller 115 coupled to a light source 110 and a projector 120. The projector 120 projects light from the light source 115 onto a stimulus region 125.

In some embodiments light source 110 may comprise one or more light emitting diode (LED) light sources. By way of example, light source 110 may be implemented as an array of LEDs which generate an optical output in response to an input current. The light source 110 may generate a coherent optical output, e.g., a LASER output, or an incoherent optical output.

Projector 120 may comprise one or more optical assemblies, e.g., lenses, to direct illumination from the light source 110 onto a stimulus region. In some embodiments the projector 120 may be passive in the sense that is may comprise one or more lenses that focus light onto the stimulus region 125, but does not actively process light output from the light source 110. In other embodiments the projector 120 may cooperate with the controller 115 to manipulate one or more characteristics of the light output from the light source 110.

The stimulus region 125 may comprise a screen or other surface suitable for illumination by the light source. By way of example, the system 100 may be incorporated into a larger image presentation system, e.g., a computer system or a digital projector system. In such embodiments the stimulus region 125 may comprise a presentation screen. In other embodiments the system 100 may be an illumination system not necessarily designed to present images. In such embodiments the stimulus region 125 may comprise a spatial region for illumination by the system 100. By way of example, in some embodiments the system 100 may comprise an emergency illumination system and the stimulus region 125 may comprise a geographic area illuminated by the system 100.

Controller 115 is coupled to the light source 110 by a suitable electrical and/or communication connection. In some embodiments the controller 115 may comprise, or be a part of, a processing device. Controller 115 comprises a jitter module 116 implements logic which performs two basic functions on the light source 110. The first function is to cycle the light source 110 between an active state, in which the light source 110 emits light, and an inactive state, in which the light source 110 does not emit light. In some embodiments the light source is cycled such that the pulse of light emitted by the light source 110 measures between 30 milliseconds and 100 milliseconds, i.e., at a frequency between 10 Hz and 33.33 Hz. In some embodiments the light source is cycled at 20 Hz, such that the pulse of light emitted by the light source 110 measures approximately 50 milliseconds.

The second function is to introduce a jitter, or semi-random time delay, into the onset of the illumination cycle of the light source 110. In some embodiments the controller introduces a jitter that measures between 0 and 30 milliseconds into the onset of each active state for the light source 110. In other embodiments the jitter measures between 0 and 19 milliseconds. By way of example, the controller 115 may comprise logic to generate a quasi-random number between 0 and n, where n represents the upper limit of the jitter threshold. Controller 115 then delays the onset of the active cycle by a time period corresponding to the quasi-random number.

In some embodiments controller 115 also comprises a spatial dither module 118 which implements logic to spatially dither the illumination output by projector 120. In such embodiments the spatial dither module 118 subdivides the stimulus region 125 into a plurality of sub regions, and independently jitters the time offset for each of the plurality of spatial regions in the stimulus region 125.

In some embodiments the light source 110 may comprise an array of independently addressable LEDs. In such embodiments the spatial dither module 118 cooperates with the jitter module 116 to subdivide the array of LEDs into a plurality of sub-arrays, each of which may be independently jittered. In other embodiments the dither module 118 cooperates with the projector 120 to subdivide the output from the light source 110 into multiple blocks, each of which may be jittered independently.

In some embodiments the sub-arrays or blocks to be jittered may be defined regions of constant sizes and dimensions. In other embodiments the sub-arrays or blocks may be constructed to be low-saliency features. By way of example, low saliency features may be generated by creating circles having randomly chosen fourier terms to module the radius of each circle versus the turning angle, using equation 1:

r(θ)=:Σᵢ₌₀ⁿaᵢ Sin(iθ)+bᵢ Cos(iθ)) Eq: 1

The a and b terms may be chosen randomly from the range {−1.0, +1.0} and the term n may be randomly chosen from {1 . . . 10}. An adjustment to the overall r(θ) function may be implemented to cause all r values to be non-zero with a finite offset. The radius, r, may then be multiplied by a random size term, using equation 2:

r_{scaled}(θ)=r(θ)\sqrt{e^{R(0,Log(50))}} Eq 2

Where the function R(0,Log(50)) generates a random real number between the range of 0 and Log(50). More broadly, a function R(lower, upper) may be used to generate a random number between a lower limit and an upper limit. The scaled function of Equation 2 results in a randomly scaled version of the modulated circle with no natural unit of size. The square root function creates a uniform distribution of filled areas. Using low-saliency features such as modulated circles, in the dithering process renders the borders between adjacent regions less detectable to the human eye.

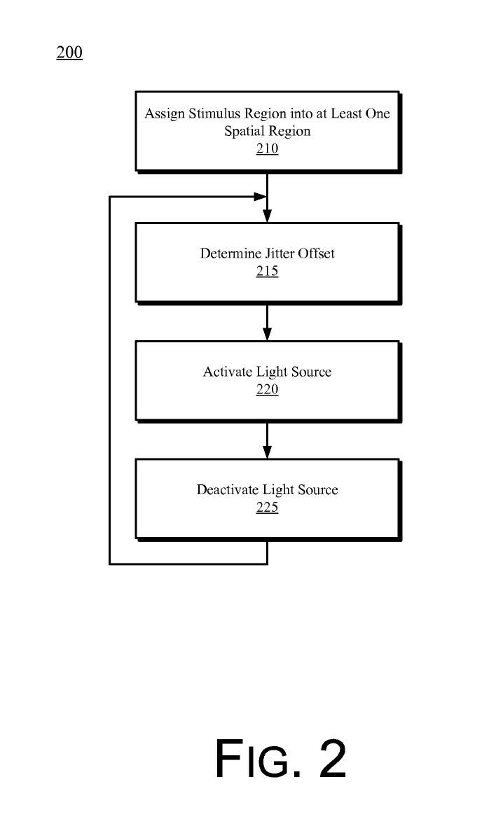

FIG. 2 is a flow diagram illustrating operations in a method to implement high efficiency illumination in accordance with some embodiments. Referring to FIG. 2, at operation 210 the stimulus region 125 may be assigned into at least one spatial region, or sub-block. Operation 210 may be performed by the spatial dither module 118, as described above. Once the stimulus region 125 has been divided into one or more spatial regions, or sub-blocks, the jitter module 116 may determine a jitter offset for each of the distinct spatial regions (operation 215). At operation 220 the jitter module activates the light source 110, and at operation 225 the jitter module 116 deactivates the light source 110. Control then passes back to operation 215 and operations 215-225 may be repeated as long as power is supplied to the system 100. Operations 212-225 thereby define a loop pursuant to which the light source is cycled between an active state and an inactive state, and pursuant to which a jitter is introduced into the time onset of the active state.

In circumstances in which the system 100 is incorporated into a larger image projection system it may be useful to apply one or more correction factors to correct for the fact that the Broca-Sulzer effect is non-linear in the intensity of the light stimulus. Dark regions of a graphic or video frame will be relatively less affected by the Broca-Sulzer effect than lighter regions of a graphic or video frame. One way to characterize the non-linearity of the Broca-Sulzer effect is that the Broca-Sulzer effect introduces a gamma defect which distorts the relationship between the applied lux and the perceived lux of light.

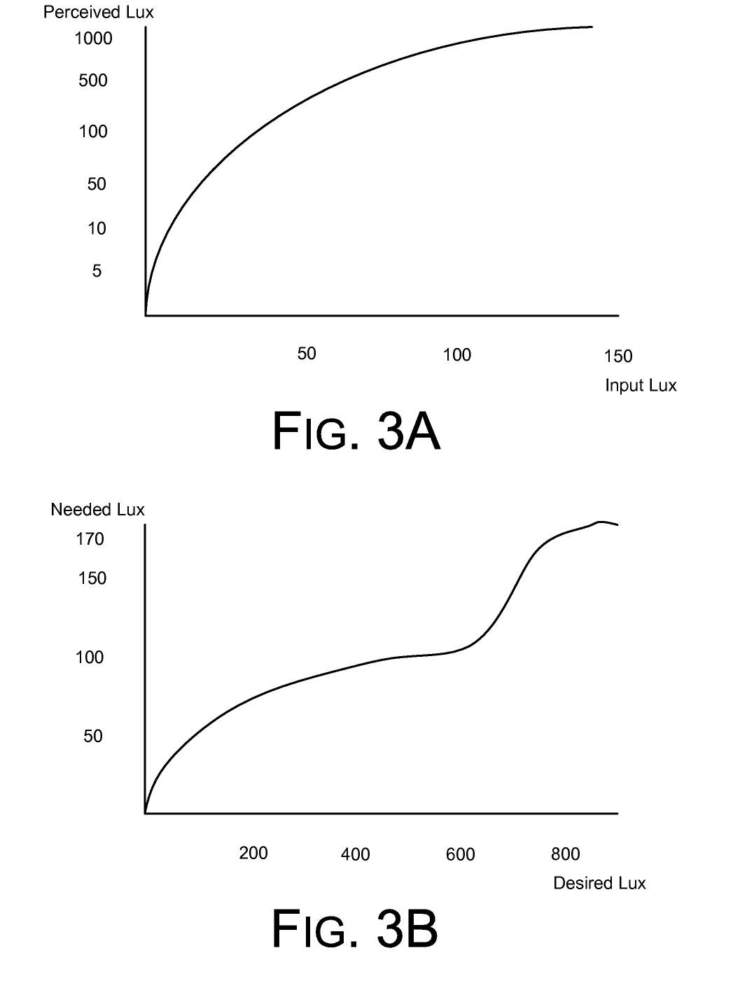

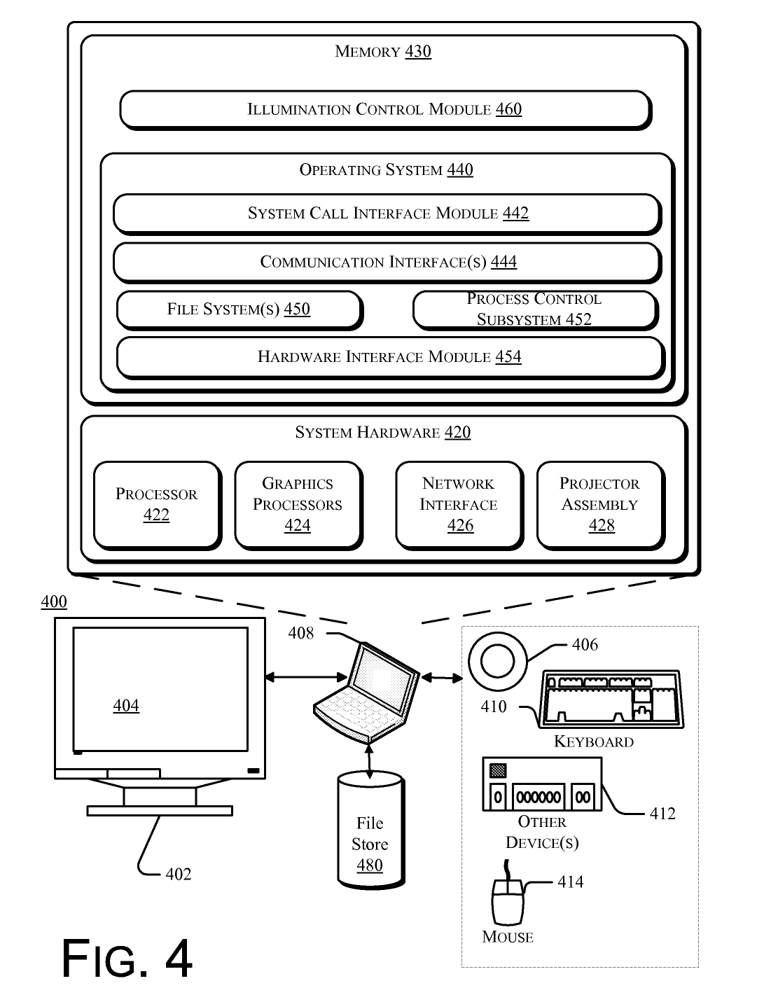

FIG. 3A is a graphic which illustrates the non-linearity of the Broca-Sulzer effect. A curve may be fit to the perceived lux as a function of the input lux. In one embodiment the relationship may be given by equation 3:

Lux_{perceived}=e^{0.1055+0.14186lux-0.001048lux}^{²}^{+2.62116×10}^{^{−6}}^{lux}^{³} Eq 2

A correction factor may be applied to each pixel of light from the light source 110 to compensate for the non-linear aspect of the Broca-Sulzer effect. FIG. 3B is a graphic which illustrates a correction factor applied to a Broca-Sulzer effect in accordance with some embodiments. Referring to FIG. 3B, in some embodiments a correction factor is applied to scale the intensity of pixels from a range of 0 (full black) to 975 (pure white) to a scale of 0 (full black) to 170 (pure white).

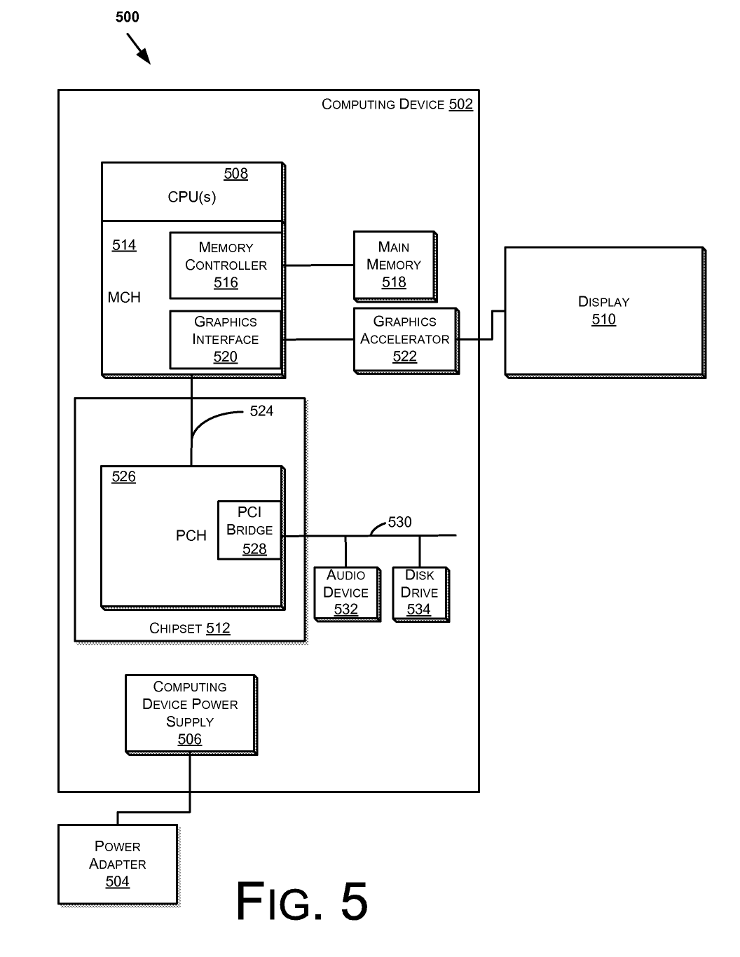

In some embodiments the system 100 may be incorporated into a computing system. FIG. 4 is a schematic illustration of an exemplary computing system 400 which may be adapted to implement high efficiency illumination in accordance with some embodiments. In one embodiment, system 400 includes an electronic device 408 and one or more accompanying input/output devices including a display 402 having a screen 404, one or more speakers 406, a keyboard 410, one or more other I/O device(s) 412, and a mouse 414. The other I/O device(s) 412 may include a touch screen, a voice-activated input device, a track ball, and any other device that allows the system 400 to receive input from a user.

In various embodiments, the electronic device 408 may be embodied as a personal computer, a laptop computer, a personal digital assistant, a mobile telephone, an entertainment device, or another computing device.

The electronic device 408 includes system hardware 420 and memory 430, which may be implemented as random access memory and/or read-only memory. A file store 480 may be communicatively coupled to computing device 408. File store 480 may be internal to computing device 408 such as, e.g., one or more hard drives, CD-ROM drives, DVD-ROM drives, or other types of storage devices. File store 480 may also be external to computer 408 such as, e.g., one or more external hard drives, network attached storage, or a separate storage network.

System hardware 420 may include one or more processors 422, at least two graphics processors 424, network interfaces 426, and a projector assembly 428. In one embodiment, processor 422 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 424 may function as adjunct processor that manages graphics and/or video operations. Graphics processor(s) 424 may be integrated onto the motherboard of computing system 400 or may be coupled via an expansion slot on the motherboard.

In one embodiment, network interface 426 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Memory 430 may include an operating system 440 for managing operations of computing device 408. In one embodiment, operating system 440 includes a hardware interface module 454 that provides an interface to system hardware 420. In addition, operating system 440 may include a file system 450 that manages files used in the operation of computing device 408 and a process control subsystem 452 that manages processes executing on computing device 408.

Operating system 440 may include (or manage) one or more communication interfaces that may operate in conjunction with system hardware 420 to transceive data packets and/or data streams from a remote source. Operating system 440 may further include a system call interface module 442 that provides an interface between the operating system 440 and one or more application modules resident in memory 430. Operating system 440 may be embodied as a UNIX operating system or any derivative thereof (e.g., Linux, Solaris, etc.) or as a Windows® brand operating system, or other operating systems.

In some embodiments the electronic device 408 may comprise a illumination module 460 which cooperates with the projector assembly 428 to implement the methods described above with reference to FIG. 2 and FIGS. 3A and 3B. The illumination module 460 may be implemented as logic instructions stored in a computer-readable medium and executable on processor 422. Alternatively, the illumination module 460 may be implemented as logic encoded in configurable circuitry, e.g., a field programmable gate array (FPGA), or may be hardwired into circuitry such as a application specific integrated circuit (ASIC), or as a component of a larger integrated circuit.

FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110 VAC to 240 VAC) to a direct current (DC) voltage ranging between about 4 VDC to 12.6 VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a controller to control a light source, wherein the controller comprises logic to:
cycle the light source between an active state and an inactivate state with a pulse duration that measures between 30 milliseconds and 100 milliseconds; and
jitter a time onset of the active state by a quasi-random time that measures between 0 and 30 milliseconds for one or more cycles.

2. The illumination system of claim 1, wherein the light source comprises at least one light emitting diode (LED).

3. The illumination system of claim 1, further comprising a projection assembly to project light from the illumination system onto a stimulus region.

4. The illumination system of claim 1, wherein:
the controller further comprises logic to:
subdivide a stimulus region into a plurality of spatial regions; and
independently jitter the time offset of multiple spatial regions by a quasi-random time that measures between 0 and 30 milliseconds for one or more cycles.

5. The illumination system of claim 4, wherein the plurality of spatial regions defines a plurality of overlapping shapes.

6. The illumination system of claim 3, wherein the controller is operable to generate a moving image for projection onto the stimulus region.

7. An electronic device, comprising:
a processor;
a light source; and
a controller coupled to the light source, wherein the controller comprises logic to:
cycle the light source between an active state and an inactivate state at with a pulse duration that measures between 30 milliseconds and 100 milliseconds; and
jitter a time onset of the active state by a quasi-random time that measures between 0 and 30 milliseconds for one or more cycles.

8. The electronic device of claim 7, wherein the light source comprises at least one light emitting diode (LED).

9. The electronic device of claim 7, further comprising a projection assembly to project light from the light source onto a stimulus region.

10. The electronic device of claim 9, wherein:
the controller further comprises logic to:
subdivide a stimulus region into a plurality of spatial regions; and
independently jitter the time offset of multiple spatial regions by a quasi-random time that measures between 0 and 30 milliseconds for one or more cycles.

11. The electronic device of claim 10, wherein the plurality of spatial regions define a plurality of overlapping shapes.

12. The electronic device of claim 9, wherein the light source is operable to generate a moving image for projection onto the stimulus region.

13. A method, comprising:
cycling a light source between an active state and an inactivate state with a pulse duration that measures between 30 milliseconds and 100 milliseconds; and
jittering a time onset of the active state by a quasi-random time that measures between 0 and 30 milliseconds for one or more cycles.

14. The method of claim 13, wherein the light source comprises at least one light emitting diode (LED).

15. The method of claim 13, further comprising projecting light onto a stimulus region.

16. The method of claim 15, further comprising:
subdividing the stimulus region into a plurality of spatial regions; and
independently jittering the time offset of multiple spatial regions by a quasi-random time that measures between 0 and 30 milliseconds for one or more cycles.

17. The method of claim 16, wherein the plurality of spatial regions defines a plurality of overlapping shapes.

18. The method of claim 15, wherein the light source generates a moving image for projection onto the stimulus region.
